(19) United States
(12) Patent Application Publication
(10) Pub. No.: US 2008/0188965 A1
(43) Pub. Date: Aug. 7, 2008

(54) REMOTE AUDIO DEVICE NETWORK SYSTEM AND METHOD

(75) Inventor: Douglas Bruey, Seattle, WA (US)

Correspondence Address: Jablonski Law Group, 11609 NE 97th St, KIRKLAND, WA, 98033, US

(73) Assignee: RANE CORPORATION, Mukilteo, WA (US)

(21) Appl. No.: 11/671,981

(22) Filed: Feb. 6, 2007

(51) Int. Cl. G06F 17/00

(52) U.S. Cl. 700/94

(57) ABSTRACT

A remote audio device network (RADN) provides a high-value solution for connecting remote audio input and output devices to audio processing equipment in a control/rack room. Costs are kept low through the use of Category 5 (CAT 5) unshielded twisted pair (UTP) cabling and standard technologies for digital audio, control data, and power transmission. Digital audio transmission breaks ground-loops and is highly resistant to EMI. Troubleshooting is simplified using built-in test methods for verifying the power, control, and audio signals. Efficiency of audio bandwidth is maintained for one and two channel input and output devices by using the AES3 (AES/EBU) encoding standard for digital audio which is designed for two-channel audio interconnect. Point-to-point wiring ensures that the DSP equipment is always aware of the location of a connected device such that control data signals allow the DSP equipment to configure and control the connected remote audio devices.

### BACKGROUND

Audio and video (A/V) systems that are deployed in various locations, such as churches, hotels, educational facilities, and restaurants, often require multiple inputs and outputs for A/V signals at many disparate locations throughout these types of facilities. For example, most hotels require an audio system to service conference rooms, a restaurant/lounge, a gift shop, offices, and a lobby. Various audio inputs and outputs are typically required at these different locations. Microphones and CD/DVD/VCR audio inputs are typically required in the conference/meeting rooms for presentations along with outputs for powered speakers or recording devices. Jukeboxes and satellite receivers are typically needed for entertainment in the restaurant/lounge. Paging stations are often placed throughout the facility at locations such as gift shops, reception desks, and offices. Conventional means of interconnecting these distributed audio systems are expensive, difficult to install, difficult to troubleshoot, and susceptible to interference and ground loops which negatively impact audio performance. These problems are described in more detail below.

FIG. 1 shows a system diagram of an A/V system 100 interconnected using conventional means. In order to maintain configurability and control of a distributed A/V system, a designated A/V control center (i.e., a control room 110) may include a number of different processing devices and A/V equipment. The control room 110 is typically secure and out-of-the way in an effort to protect the equipment and hide the cacophony of signal cables. Any number of components may be deployed in a control room 110 to accomplish the core features of the A/V system 100. Such features include signal reception, routing, mixing, conditioning, and distribution. As a result, a typical control room 110 may include several A/V components 115 including CD players, DVD players, satellite signal receivers, amplifiers, digital signal processors (DSP), analog signal processors, and the like. In addition to the equipment in the control room 110, other A/V equipment is often located at many different places throughout the system 100.

Various A/V equipment and audio cabling distributed throughout the facility provide a signal path for audio to and from the control room. For example, a jukebox 121 in dining area 120, satellite TV receivers 131 and TVs 133 in a bar area 130, microphones 141a-c in a small meeting room 140, an assisted listening system 155 in an auditorium 150, etc. In short, A/V devices are typically deployed in many disparate locations in any given facility, and signal cable 195 must be routed to each and every device from the control room 110 in order to be part of the control and configuration capabilities provided by a control room 110. As a result, all signal transmissions between remotely deployed A/V equipment and control room A/V equipment are accomplished via analog cabling or digital cable as discussed further below.

In most conventional systems, the inputs and outputs of the A/V equipment in the control room 110 are analog. In analog signal transmission via the various cable runs 195, shielded audio cabling is used to connect the control room 110 equipment to other audio equipment throughout the facility. This approach to interconnecting the conventional audio system 100 causes several problems.

Shielded audio cable is more expensive than the more common, unshielded cable that is typically used in computer networking systems. In order to provide a suitable signal path for long cable runs for analog signals, shielded audio cable is required. Also, the standard audio connectors and terminations used to interconnect the cables are more expensive than standard data cable terminations (e.g., RJ-45 terminations). In addition to the cable runs, conduit 197 used to carry multiple cable runs is a significant expense. Using analog cable requires separation of low level signals (e.g., microphone output signals) from higher level signals (e.g., mixer output signals or loudspeaker input signals) to avoid electromagnetic interference (EMI) between the signals. This separation is typically achieved by routing low level signals through a separate conduit 197. It is expensive to add conduits 197 to an installation.

Analog cabling is more susceptible to ground loops. Due to the typically long distances between control room A/V equipment and remote A/V equipment, ground potentials may be significantly different from one location to the next. Consumer A/V equipment such as CD/DVD players, satellite receivers 131, laptop computers 153, etc. are often not designed to account for these lengthy cabling deployments. Thus, deploying consumer A/V equipment in conventional installations often results in ground loops that produce unacceptable noise in one or more audio channels. Additionally, a long cable run for any given channel may act as an antenna making the signal cable more susceptible to electromagnetic interference (EMI). If the A/V equipment connected to either end of the cable is not sufficiently insulated from this interference, unacceptable noise will result in the audio channel.

Troubleshooting and installation of analog cabling is problematic. Cable mismatch, erroneous patching, and broken cables are difficult to troubleshoot because the two ends of the analog cable are typically hundreds of feet apart and in completely different rooms. Furthermore, common methods of terminating analog cables are labor intensive. Euroblock connectors require screwing down each wire into the connector. Other common terminations, such as XLR, TRS, or RCA plugs, all require the installer to solder the wires into place and then assemble the connector.

An additional problem arises when an end-user requires the flexibility to accommodate a dynamic number of inputs or outputs at a remote location. For example, a meeting room 140 may only require one or two microphones 141a and 141b. These microphone 141a and 141b may be accommodated by a conventional 2-XLR input wall-plate 142 which may be commonly located near the most typical location for a single presenter. Occasionally, however, a panel of people may be present, requiring a microphone for each person which may include at least a third microphone 141c. The audio system 100 must accommodate this occasional increase in microphone inputs at a given location. It is inefficient to provide a maximum number of inputs (i.e., more 2-XLR inputs 142) that may be needed in each room at each potential presentation location.

One conventional solution that provides additional flexibility and expandability includes deploying a stand-alone mixer 147 that provides additional inputs and outputs at a remote location. A mixer 147 typically provides a number of additional microphone inputs and is capable of mixing the additional microphone signals into a single analog audio signal. Then, by conventional means described above, the single analog signal may be transmitted back to the control room 110 through one of the wall-plate connections 142. Again, however, there are problems with this solution.

Using conventional audio mixer 147 to increase the number of microphone inputs at a remote location is still a limited solution. The audio signal transmitted back to the control room 110 is an analog signal and, therefore, is subject to all the problems described above with respect to a conventional analog system 100. Also, analog audio connection from the control room 110 to the mixer does not provide a path for control information exchange between the DSP equipment 111 and the mixer 147. Therefore, the DSP equipment 111 cannot control the mixer 147. Allowing the DSP equipment to control the mixer 147 would eliminate the need to train facility staff to configure and control the mixer 147.

All of the above problems associated with analog distribution systems may typically be overcome by moving to a digital distribution system. A digital distribution system includes one or more audio devices communicating over a multiplexed communication medium, such as Ethernet. Common digital distribution systems include CobraNet™ or Ethersound™ audio-over-Ethernet protocols. The audio devices may optionally accept power from the communication medium as in the case of power-over Ethernet equipment. When dealing with digital signals, problems associated with ground loops and EMI are typically alleviated.

FIG. 1 may also represent one conventional application of a digital distribution system as deployed in a conference room 160. One solution is to deploy a packet switched local area network (LAN) 182 (e.g., Ethernet). The network cable may connect to an audio device 162 that may connect to multiple microphones 161a-c deployed in a general location (e.g., seats around a conference table 160). The audio device 162 may multiplex each signal for transmission over the connected LAN 182. As a result, various A/V components that may be deployed in a control room 110 may access the LAN 182 using the same protocol as the audio device 162 to receive the conference room 160 microphone 161a-c signals for processing (e.g., routing and mixing). The DSP equipment 111 may perform automatic mixing of the microphone signals from the conference room 160. This mixing capability may be used to accomplish the same objectives as the mixer 147 in the meeting room 140. While this solution alleviates several problems associated with the mixer 147 (e.g., Ethernet-based equipment does provide some additional flexibility due to the digital control connection to the audio equipment 162), it gives rise to others.

Ethernet-based audio equipment is limited by its inability to detect its physical location. When the audio device 162 is used to temporarily add microphone inputs to a room, the device may be shared between multiple rooms in a facility (e.g., the audio device 162 is located in the conference room 160 one day and the meeting room 140 another day). Commonly, the configuration of the audio device must change depending on its location. The audio device 162 cannot detect its location (i.e., whether it is in the meeting room 140, or the conference room 160). Therefore, staff at the facility must be trained to properly configure the audio device 162 each time it is deployed in a different room.

Technologies available for transmitting many channels of audio over Ethernet are relatively expensive. The protocols commonly used for transmission of digital audio over Ethernet are proprietary. Licensing this technology adds cost to the audio device 162. Audio devices must feature eight or more audio channels to effectively amortize the cost of the license and specialized electronic parts. However, most installations require only one or two audio channels at a remote location.

### BRIEF DESCRIPTION OF THE DRAWINGS

The foregoing aspects and many of the attendant advantages of the claims will become more readily appreciated as the same become better understood by reference to the following detailed description, when taken in conjunction with the accompanying drawings, wherein:

FIG. 1 shows a system diagram of a conventional A/V system 100 that illustrates a number of problems associated with conventional audio/video systems.

FIG. 2 shows a system diagram of a remote audio device network (RADN) 200 according to an embodiment of the invention;

FIG. 3 shows a block diagram of the host device 211 of FIG. 2 according to an embodiment of the invention;

FIG. 4 shows a block diagram of a remote audio device port (RADP) 310 as implemented in the host device 211 of FIG. 2 according to an embodiment of the invention;

FIG. 5 shows a block diagram of the remote audio device (RAD) 201 of FIG. 2 according to an embodiment of the invention;

FIG. 6 shows a block diagram of a RADP 510 as implemented in the RAD 201 of FIG. 2 according to an embodiment of the invention;

FIG. 7 shows a cutaway view of a remote audio device network cable (RADC) 295 that may be used to communicatively couple a various components of the RADN 200 of FIG. 2 according to an embodiment of the invention.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

A remote audio device network (RADN) provides a high value solution for connecting remote audio input and output devices to the audio processing equipment in a control/rack room. The cost of connecting remote devices is kept low through the use of Category 5 (CAT 5) unshielded twisted pair (UTP) cabling and standard technologies for digital audio, control data, and power transmission. Digital audio transmission breaks ground-loops and is highly resistant to EMI. Troubleshooting is simplified using built-in test methods for verifying the power, control, and audio signals. Efficiency of audio bandwidth is maintained for one and two channel input and output devices by using the AES3 (AES/EBU) encoding standard for digital audio which is designed for two-channel audio interconnect. Point-to-point wiring ensures that the DSP equipment is always aware of the location of a connected device such that control data signals allow the DSP equipment to configure and control the connected remote audio devices.

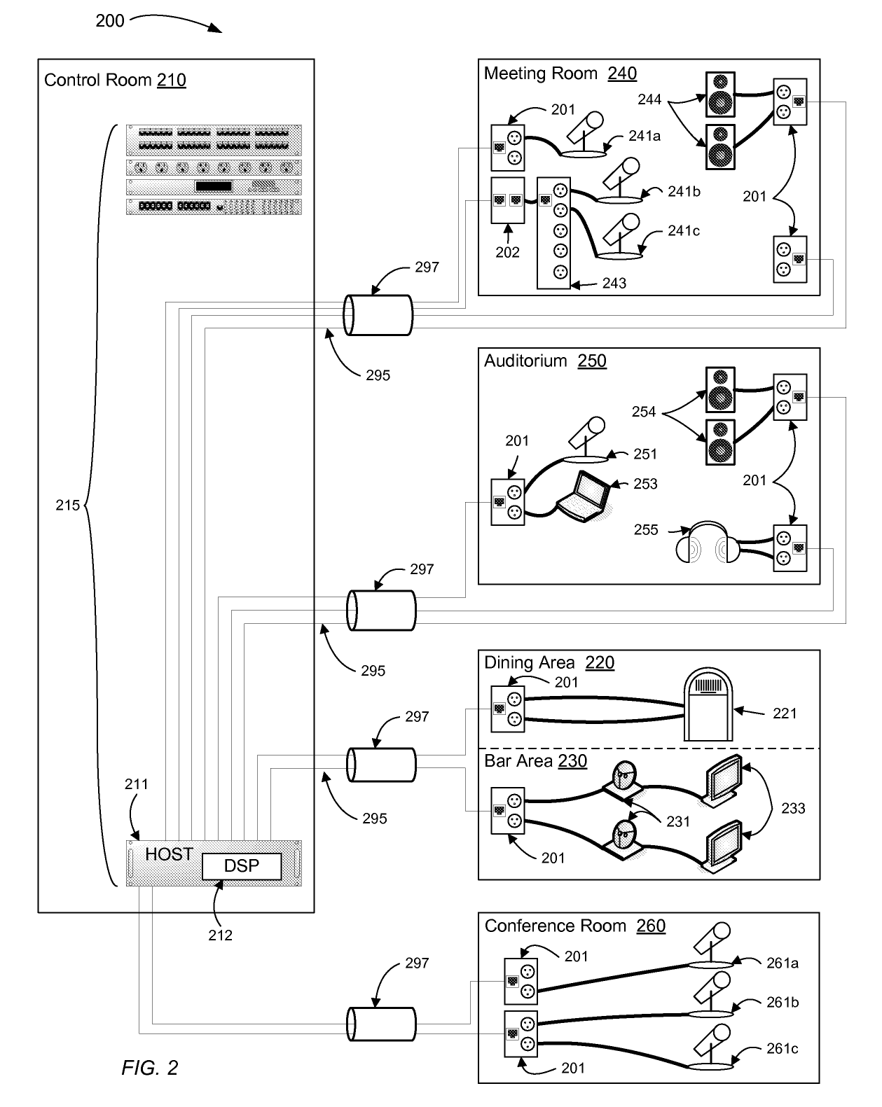

FIG. 2 shows a system diagram of an RADN 200 that takes advantage of various deployed audio and video components. The RADN 200 is comprised of several RADs 201, 202, 243 deployed at various locations that may or may not be in proximity to a central control room 210. The differences between these RADs are detailed below but for the purposes of this disclosure, an RAD will be referenced as RAD 201 of FIG. 2. Each RAD 201 is typically communicatively coupled to a dedicated remote audio port (not shown in FIG. 2) within a host device 211 at the control room 210. The communicative coupling between an RAD 201 and the host device 211 is realized through a remote audio device cable 295 (RADC) that may comprise a CAT-5, UTP cable containing four twisted pairs of wire. Typically, the four twisted pairs may be used for four differential signals between the RAD 201 and the host device 211: 1) power; 2) control data; 3) digital audio input; and 4) digital audio output.

Specific features of the RADN 200 include the ability to handle four particular signals used in the control and distribution of audio signals. These four signals include a power signal, a control data signal, at least one audio input signal, and/or at least one audio output signal. These four signals may be implemented using various means and communication protocols, but in one embodiment the power signal is 48-Volt DC, the control data signal is transmitted using a RS-485 serial protocol and physical layer, and the audio input/output signals are encoded using the AES3 (AES/EBU) standard and transmitted using the RS-422 physical layer.

The power signal may be used to provide power to the RAD 201. The RAD 201 may also supply any portion of the power to connected devices (e.g., condenser microphones that need 48-VDC phantom power to operate). Alternatively, the RAD 201 may derive its power from a source other than the host device 211. For example, an RAD automixer 243 (described in detail below) may derives its power from AC mains that are typically plugged into a conventional electrical wall outlet.

The control data signal is typically a differential, multi-drop, half duplex, serial data signal. This type of signal allows a single pair of wire to transport bi-directional data. Additionally, the control data signal may be shared among several devices, (e.g., a host device 211, an RAD wall-plate 202, and a RAD automixer 243). Differential signaling makes the data highly resistant to EMI.

The audio signal is typically encoded using the AES3 digital audio standard and transmitted using RS-422 transceivers. AES3 data transmission is point-to-point. Each AES3 signal utilizes a transmitter and a receiver. RS-422 uses differential signaling which improves resistance to EMI. With such an RADN 200 in place, adding A/V equipment to the RADN 200 throughout the facility may be easily handled.

As A/V equipment is often located at many different places throughout the RADN 200, equipment need only be connected to the closest RAD 201 for the control room 210 to have the ability to route and control the signals to and from any locally or remotely connected A/V equipment. For example, a jukebox 221 in dining area 220, satellite TV receivers 231 and TVs 233 in a bar area 230, microphones 241a-c in a small meeting room 240, assisted listening systems 255 in an auditorium 250, etc. may each individually be connected to the system 200 through various local RADs 201. Other examples include speakers 244 and 254 in various locations as well as microphones 261a-261c that may be connected through additional layers of distribution components, such as local RADs 201 in a conference room 260. Using an RADN 200 to extend the audio distribution, configuration, and control capabilities of the control room 210 to disparate locations throughout a facility has many advantages over conventional analog and digital audio distribution methods.

One advantage is the use of digital audio signal transmission instead of analog audio signal transmission. Digital audio transmission enables one skilled in the art to easily isolate the ground connections of the A/V equipment from the control room 210. This isolation may be accomplished by a variety of means including magnetic (transformer), optical, resistive, capacitive, etc. Furthermore, digital audio signals are less susceptible to EMI from the environment around the transmission line (e.g., RADC 295). By transferring the audio data digitally, electromagnetic interference is far less likely to degrade the signal to a level that produces noise in the audio channel of the remote audio network. Also, improved resistance to EMI enables significant cost reductions.

A system implemented using a RADN 200 may cost significantly less than a similar conventional system 100 implemented using conventional analog audio distribution. Increased resistance to EMI enables contractors to run all RADC 295 in the same conduit 297 to each location (e.g., bar area 230, meeting room 240, etc.) by eliminating the various separate conduits 197 required for each location to separate analog signals of different levels from each other and to separate analog signals from digital signals. Robust RADN 200 signals also support the use of CAT-5, UTP cable as is typical for an RADC 295. CAT-5, UTP is less expensive than shielded audio cable. Furthermore, a single RADC 295 can carry up to four audio channels whereas analog audio cable runs traditionally carry a single audio channel. Hence, a RADN 200 has the potential of reducing the number of discrete cable runs by 75% in any given facility. Also, RJ-45 terminations commonly applied to CAT-5 cabling are less expensive than traditional analog audio cable termination implementations. Furthermore, RADC 295 signals may take advantage of existing (or soon-to-be installed) information technology (IT) networks such that CAT-5 cable already part of an IT install may be used for the RADN 200. This reduces cabling costs in the audio system budget. In addition to cabling cost reduction, the remote audio network simplifies troubleshooting which leads to further cost/time savings.

The RADN 200 may include integrated troubleshooting features that save contractors and installers time and money over conventional analog distribution means. Power indicators for each RAD 201 and each connection to the host device 211 may instantly show whether the power signal is present and at an acceptable level. Communications indicators may instantly show that the control data signal is present and acceptable. Audio signal indicators may instantly show that the digital audio signals (input and output) are present and acceptable. In other words, the host device 211 and each RAD 201 are able to troubleshoot their own interconnection and report the status to a user.

The control data signal of the RADN 200 may extend the configuration and control capability of the DSP equipment 212 to each RAD 201. The RAD 201 may be capable of signal processing. The processing in the RAD 201 may share information with the DSP equipment 212 via the RADN 200, allowing the processing in the RAD 201 to act as an extension of the configuration and control capabilities of the DSP equipment 212. Processing in the RAD 201 may take some processing burden off of the host device 211 in the control room 210. This may reduce the capacity of DSP processing required in the control room 210, and, therefore, may reduce the cost of the DSP equipment 212. Further advantages are realized as the RADN 200 enables deploying the system 200 over a longer period of time.

Typical DSP functions may include signal mixing, compression, excitation, signal delay, amplification, expansion, equalization, frequency shifting, and feedback suppression. This is a non-exhaustive list as any number of DSP functions may be realized at any component in the RADN 200.

Deploying an RADN 200 that exceeds the current needs of a facility is cost effective, and simplifies future upgrades to the facility. The expense and limited utility of conventional analog audio wiring makes deployment of extra analog audio cabling 195 impractical. In contrast, facilities often install extra runs 295 of CAT-5 cable to support future growth of their local area networks and other IT infrastructure. Adding extra runs is desirable due to the low cost of CAT-5, UTP cabling and the ease of installation during facility construction/renovation. The RADN 200 is operable to support CAT-5, UTP cabling and allows the RADN 200 to expand over time by using the extra CAT-5, UTP cabling already deployed in a facility.

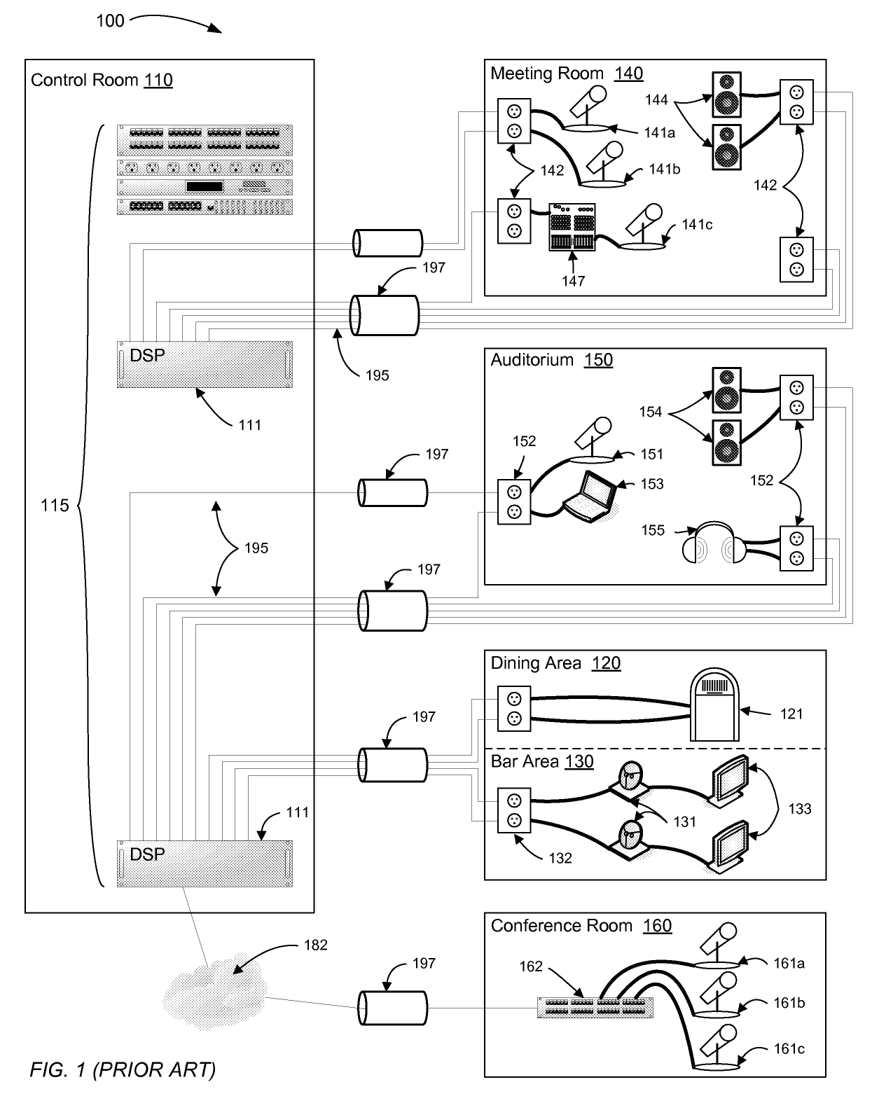

The RADN 200 also improves over the conventional digital audio distribution described in FIG. 1. The RADN 200 provides cost savings over conventional digital audio distribution methods. Using low-cost, non-proprietary technologies for control communications (e.g., RS-485 serial encoding and transmission) reduces the cost of the RADN 200 by eliminating more expensive proprietary equipment and technologies and enabling the use of off-the-shelf components. Likewise, using low-cost, non-proprietary technologies for audio data transmission (e.g., AES3 serial encoding and RS-422 transmission) has the same effect.

The RADN 200 typically uses point-to-point connections which eliminate the need for Ethernet switches. Furthermore, the RADN 200 is designed to efficiently transport up to four audio channels per run (RADC 295) unlike conventional digital distribution methods which are most cost effective when transporting eight or more audio channels per run. The point-to-point wiring of the RADN 200 provides other benefits over conventional digital audio distribution technologies.

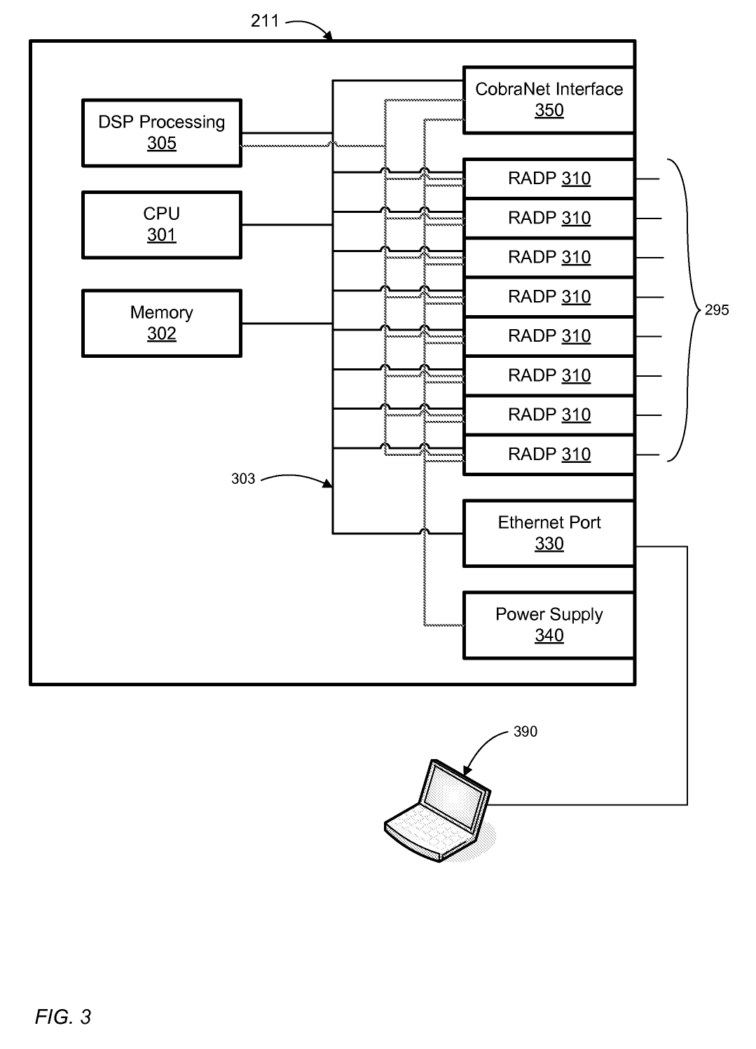

FIG. 3 shows a block diagram of the host device 211 of FIG. 2 according to an embodiment of the invention. The host device 211 may be any electronic equipment having one or more remote audio digital ports (RADP 310) and operable to extend the functions of a connected host device 211. Performing host device 211 functions typically requires a CPU 301 coupled to a bus 303 and a memory 302. A host device 211 may also provide power to various coupled RADs 201 (not shown in FIG. 3) via the power connection of the respective RADP 310 via the RADC 295. Supplying power to an RAD 201 typically requires at least one power supply 340 coupled to each RADP 310.

A host device 211 may have any number and/or types of audio inputs or outputs, communication ports, processing capabilities, indicators, etc. The host device 211 may include one or more components for manipulating audio signals and is collectively referred to as digital signal processing (DSP) 212. DSP 212 provides the capability for a coupled RAD 201 to perform functions such as mixing, routing, filtering, etc. Other audio interfaces may be included in the host device 211 and coupled to the bus 303, enabling distribution of audio signals via various protocols, standards, or methods.

For example, the host device 211 may include a CobraNet™ interface 350 to couple the host device to a CobraNet™ Audio Network. Further, communication ports, such as an Ethernet port 330, may be coupled to the bus 303 such that the host device 211 may communicate with any other Ethernet-enabled device. For example, a portable laptop computer 390 may interface the RADN via the Ethernet port 330 in order to configure the RADN 200 using a local software package on the laptop 390. A communications port such as this may be used to control and configure the host device 211 and any RADs 201 coupled to the host device via the RADPs 310. This configuration and control may be realized using any protocol or method supported by the chosen communications port.

Employing point-to-point wiring for the RADN 200 offers two advantages over conventional digital audio distribution. First, point-to-point wiring eliminates the cost of purchasing, installing, maintaining, and troubleshooting Ethernet switches and other network infrastructure required for packet-switched networks. Second, each RADP 310 has a single physical location. Therefore, if an RAD 201 is detected on the RADP 310, the host device 211 knows where the RAD 201 is located, unlike Ethernet networks which (by design) hide the topology of the network from the network nodes. Subsequently, the host device 211 may configure the RAD 201 automatically for that location using the control data signal. Therefore, the end-user has nothing to setup as the RAD 201 provides for components to simply be plugged in to function in the system 200.

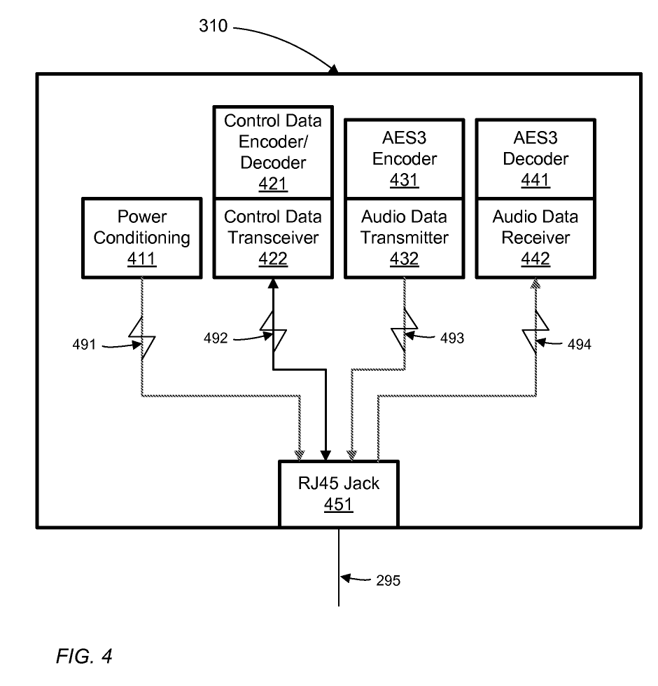

FIG. 4 shows a block diagram of a RADP 310 of the host device 211 shown in FIG. 3 according to an embodiment of the invention. One function of the RADP 310 is to physically and logically provide a signal path for the power signal 495, the control data signal 492, and audio signals 493 and 494 from the host device 211 to a coupled RADC 295.

A distribution power signal 491 may be generated from a power conditioning component 411 that manipulates a source power signal received from a power supply (340 in FIG. 3) in the host device 211. Power conditioning may include voltage regulation, current limiting, RF filtering, transient suppression, ground isolation, etc.

A control data signal 492 may be transmitted and received via a transceiver 422 which may include signal processing such as differential signal driving and receiving capabilities, RF filtering, transient suppression, ground isolation, etc. The transceiver 422 may exchange data with the control data encoder/decoder 421 which may encode the data for transmission or may decode received data for processing (e.g., a UART).

An audio output signal 493 may be generated by an audio data transmitter 432, which may include signal processing such as differential signal driving capabilities, RF filtering, transient suppression, ground isolation, etc. The audio output signal 493 is typically encoded by the AES3 encoder 431 before transmission. Similarly, an audio input signal 494 may be received by the audio data receiver 442, which may also include signal processing capabilities such as differential signal receiving capabilities, RF filtering, transient suppression, ground isolation, etc. The audio input signal 494 may be decoded by the AES3 decoder 441 after reception. All RADN 200 signals are physically transmitted and received through a coupled RADC 295 using a common connector (e.g., an RJ-45 jack 451).

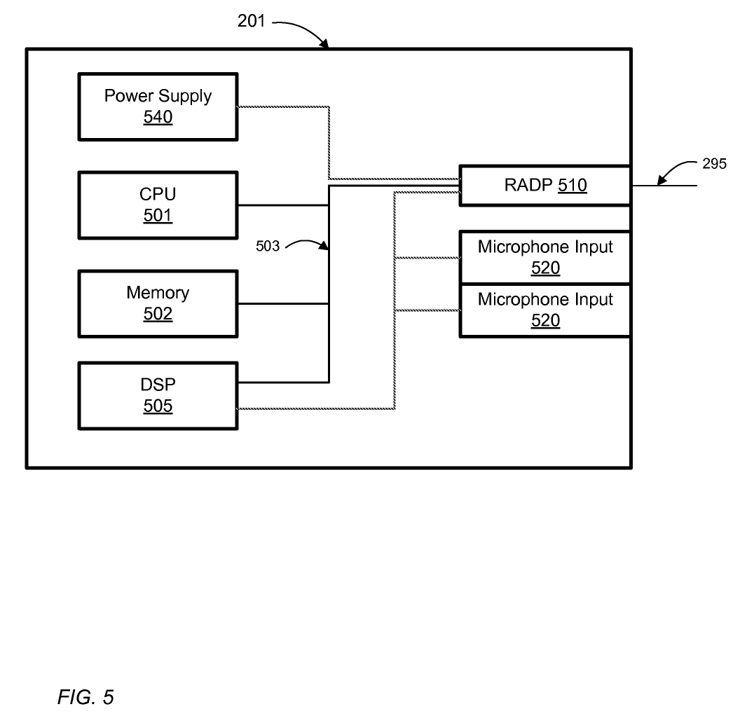

FIG. 5 shows a block diagram of an RAD 201 of FIG. 2 according to an embodiment of the invention. In general, an RAD 201 is any device that connects to an RADN 200 and acts as a slave to a host device 211. The RAD 201 may use any or all of the four signals available on the RADN 200 (i.e., power, audio in, audio out, and control). These RADN 200 signals may be transmitted to and from an RAD 201 via an RADC 295 coupled to a local RADP 510. In addition to a RADP 510, an RAD 201 may also have any number of signal interfaces that may be used as inputs (e.g., microphone inputs 520) or outputs, communication ports, indicators, etc. Typical signal interfaces include an XLR connector, a Euroblock connector, a ¼ inch phone jack, an RCA plug, a banana plug, a tele-type plug, a cannon plug, a Speakon® plug, a D-sub connector, and an optical interface.

An RAD 201 may even act as a secondary host device for its own secondary RADN. Additionally, the RAD 201 may include any number of components operable to provide analog or digital signal processing, collectively shown as DSP 505) to accomplish any desired signal manipulation. For example, DSP 505 functions may include processing microphone inputs, processing consumer equipment inputs, processing pro equipment inputs, source selection, processing consumer equipment outputs, processing pro equipment outputs, providing distribution amplification, providing mixing, etc.

RADs 201 may be used to expand the number of inputs to the host device 211. A typical RAD 201 may include mixing and signal routing to reduce the number of inputs to two audio channels, and transmit those channels back to the DSP equipment using the digital audio input signal 494. For example, as described above, facilities often require a temporary increase in the number of microphones in a meeting or conference room.

To accomplish this scenario using remote audio devices an RAD automixer 243 is available. The RAD automixer 243 plugs into an RJ-45 jack in the wall of the meeting/class room which is wired to an RADP 310 on the back of the DSP equipment 212. The RAD automixer 243 automatically mixes the microphones into one audio channel. Additionally, other inputs may be mixed, at predetermined levels, into the other audio channel available on the digital audio input signal 494. The control data signal 492 may be used to communicate information about other microphone inputs in the room. This allows the RAD automixer 243 in any location (e.g., in the DSP equipment 211, and RAD 243) to automatically adjust their mixes with respect to the gain of all connected microphones (e.g., microphones 141a-c).

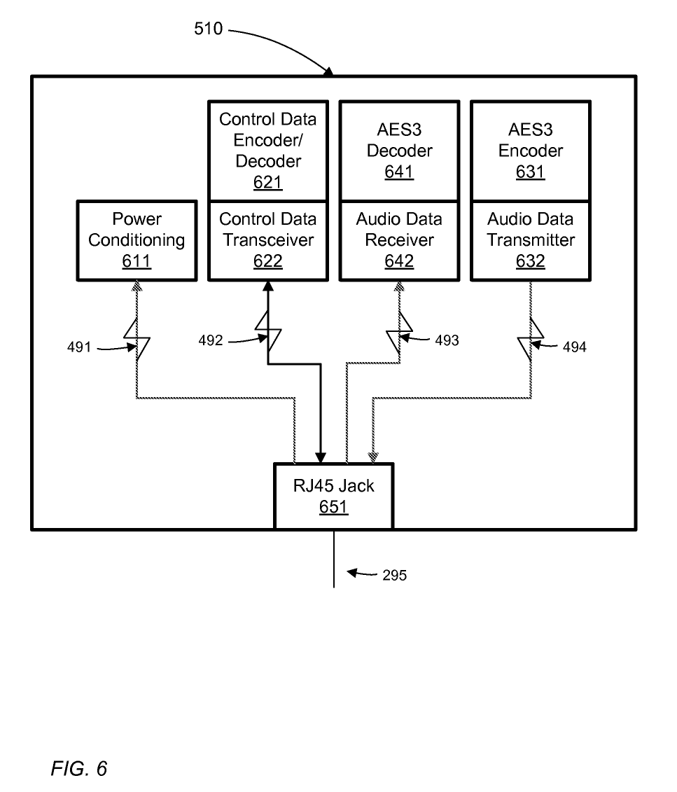

FIG. 6 shows a block diagram of a RADP 510 of the RAD 201 shown in FIG. 5 according to an embodiment of the invention. One function of the RADP 510 is to physically and logically provide a signal path for the power signal 491, the control data signal 492, and audio signals 493 and 494 from the RAD 201 to a coupled RADC 295.

A distribution power signal 491 may be received by a power conditioning component 611 that manipulates a source power signal received from a power supply (340 in FIG. 3 in the host device 211) via the RADC 295. Power conditioning may include voltage regulation, current limiting, RF filtering, transient suppression, ground isolation, etc.

A control data signal 492 may be transmitted and received via a transceiver 622 which may include signal processing such as differential signal driving and receiving capabilities, RF filtering, transient suppression, ground isolation, etc. The transceiver 622 may exchange data with the control data encoder/decoder 621 which may encode the data for transmission or may decode received data for processing (e.g., a UART).

The audio output signal 493 may be received by an audio data receiver 642, which may include signal processing such as differential signal driving capabilities, RF filtering, transient suppression, ground isolation, etc. The audio output signal 493 is typically decoded by the AES3 decoder 641 before transmission. Similarly, the audio input signal 494 may be generated by the audio data transmitter 642, which may also include signal processing capabilities such as differential signal receiving capabilities, RF filtering, transient suppression, ground isolation, etc. The audio input signal 494 may be encoded by the AES3 encoder 641 before transmission. All RADN 200 signals are physically transmitted and received through a coupled RADC 295 using a common connector (e.g., an RJ-45 jack 651.

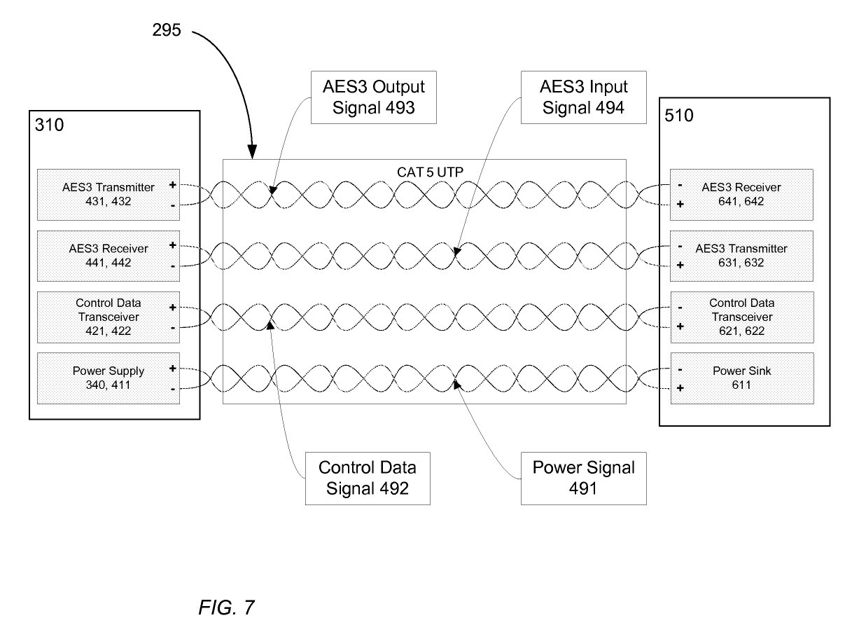

FIG. 7 shows a cutaway view of an RADC 295 that may be used to communicatively couple an RADP 510 of an RAD 201 to an RADP 310 in a host device 211 as shown in the RADN 200 of FIG. 2 according to an embodiment of the invention. The RADC 295 connects one RADP 310 at the host device 211 to one RADP 510 on one RAD 201. The RADC 295 provides the transmission medium for all RADN signals 491-494. The RADC 295 is typically CAT-5, UTP cable terminated on each end by a standard RJ-45 connector. Cabling other than CAT-5, UTP may be used, as long as it supports transmission of a suitable combination of the four signals (power 491, control data 492, digital audio input data 494, and digital audio output data 493). An alternate cable should also support the minimum cable lengths and data rates available using CAT-5, UTP.

A cable chosen for the RADC 295 should have characteristics that satisfy minimum specifications for reliable communications. An RADC 295 impedance and length are typically constrained based on the design of the digital audio transmitters 432 and 632 and receivers 442 and 642, control data transmitters and receivers 422 and 622, and power supplies 411 and 611. Both impedance and length are typically limited to values which guarantee reliable transmission of audio data, control data, and power.

In an alternative embodiment, two of these signal pairs may be combined. For example, the power signal 491 and control data 492 may be realized on a single pair of wires. In another example, power 491 and audio data 493 and/or 494 may be combined onto a single pair of wires. This would reduce the number of pairs used, such that the additional pairs may go unused or may be used for other purposes, such as additional power, audio, or control signals.

The RADN 200 may be used to transmit any combination of its four signals in the absence of the others, e.g., only power 491 and control data 492, only power 491, or only audio data 493 and/or 494. For example, a RAD 201 may be used as a Remote Audio Repeater (RAP). In this example, a RAD uses the power signal 491 to retransmit control 492 and audio data 493 and/or 494, extending transmission distances from the host device 211 equipment to the RAD 201. Another example includes an RAD wall-plate 202 wherein an RAD 201 uses the power 491 and control data signals 492 to report status of the host device 211 at the location where the RAD 201 is connected.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. An audio network system comprising:
a host device having a plurality of remote audio device ports, each remote audio device port operable to transmit and receive at least one audio signal;
a plurality of remote audio devices, each remote audio device operable to transmit and receive at least one audio signal; and
a plurality of remote audio network cables, each remote audio network cable connecting at least one remote audio device port with at least one remote audio device, the remote audio device cable operable to facilitate the transmitting and receiving of the at least one audio signal and operable to facilitate the transmitting of a power signal and a control signal to the at least one remote audio device.

2. The audio network system of claim 1, wherein the host device further comprises at least one component operable to provide digital signal processing for the at least one audio signal.

3. The audio network system of claim 2, wherein the digital signal processing comprises at least one of the group comprising: signal mixing, compression, excitation, signal delay, amplification, expansion, equalization, frequency shifting, and feedback suppression.

4. The audio network system of claim 1, wherein the host device further comprises an Ethernet port operable to facilitate communication with an Ethernet-ready device.

5. The audio network system of claim 1, wherein the host device further comprises an audio interface for facilitating transmitting and receiving at least one second audio signal different from transmitting and receiving the at least one audio signal between the remote audio device port and the remote audio device.

6. The audio network system of claim 1, wherein the remote audio device port further comprises:
a power conditioning circuit operable to manipulate a power signal to a suitable signal quality;
a control signal circuit operable to encode and decode a control signal for facilitating signal processing
an audio signal circuit for enabling transmitting and receiving of one or more audio signals.

7. The audio network system of claim 1, wherein the remote audio device port further comprises an RJ-45 interface operable to couple with the remote audio device cable.

8. The audio network system of claim 1, wherein the remote audio device further comprises at least one XLR input operable to facilitate the coupling of a microphone.

9. The audio network system of claim 1, wherein the remote audio device further comprises at least one XLR output operable to facilitate the coupling of a speaker.

10. The audio network system of claim 1, wherein the remote audio device further comprises at least one input operable to facilitate the coupling of an automixer.

11. The audio network system of claim 1, wherein the remote audio device comprises a remote audio repeater.

12. The audio network system of claim 1, wherein the remote audio device cable comprises Category 5, unshielded twisted pair cabling terminated by an RJ-45 connector.

13. A method for manipulating audio signals in an audio network system, the method comprising:
from a host device that includes a remote audio device port communicatively coupled to a remote audio device via a remote audio device cable:
transmitting at least one audio signal to the remote audio device;
controlling at least one control feature of the remote audio device; and
providing a power signal to the remote audio device.

14. The method of claim 13, further comprising receiving at least one audio signal from the remote audio device.

15. The method of claim 13, further comprising controlling at least one control feature of the host device via a control signal generated from the remote audio device.

16. The method of claim 13, wherein the controlling at least one control feature comprises controlling a control feature from the group comprising: differential signal driving and receiving capabilities, RF filtering, transient suppression, ground isolation, and voltage regulation, signal mixing, compression, excitation, signal delay, amplification, expansion, equalization, frequency shifting, and feedback suppression.

17. The method of claim 13, wherein the transmitting the at least one audio signal comprises transmitting the at least one audio signal in an AES3 signal format.

18. A remote audio device, comprising:
at least one audio signal interface operable to provide an input/output interface for an audio component; and
a remote audio device port operable to facilitate transmitting a signal from the audio signal interface to a remote audio device cable, the remote audio device port comprising:
a power conditioning circuit operable to manipulate a power signal to a suitable signal quality;
a control signal circuit operable to encode and decode a control signal for facilitating signal processing
an audio signal circuit for enabling transmitting and receiving of one or more audio signals.

19. The remote audio device of claim 18 wherein the at least one signal interface comprises an interface from the group comprising: an XLR connector, a Euroblock connector, a ¼ inch phone jack, an RCA plug, a banana plug, a tele-type plug, a cannon plug, a Speakon® plug, a D-sub connector, and an optical interface.

20. The remote audio device, further comprising an RJ-45 interface operable to facilitate transmitting a signal from a connected remote audio device cable to the audio signal interface.
